(19) United States
(12) Patent Application Publication
(10) Pub. No.: US 2019/0261659 A1
(43) Pub. Date: Aug. 29, 2019

(54) Natural and Nutritional Colorant for Food and Beverage, Method and Composition

(71) Applicant: Le Thuy Vuong, Elk Grove, CA (US)

(72) Inventor: Le Thuy Vuong, Elk Grove, CA (US)

(21) Appl. No.: 15/904,396

(22) Filed: Feb. 25, 2018

(51) Int. Cl. A23L 5/44; A23K 20/179; A23K 50/40; A23L 33/00; A23L 33/105; A23L 2/58; A23L 7/196

(52) U.S. Cl. CPC A23L 5/44; A23K 20/179; A23K 50/40; A23V 2002/00; A23L 33/105; A23L 2/58; A23L 7/196; A23L 33/40

(57) ABSTRACT

The present invention describes methods and compositions to add natural color and nutrients to food and beverage products, using the seed pulp (aril) of Momordica cochinchinensis Spreng (Gac, redmelon, gacmelon). The fruit contains high concentrations of carotenoids and antioxidants. Other nutrients are vitamin C, vitamin E and essential fatty acids. Due to high concentrations of carotenoids, the aril has an intense color, ranging from deep orange to red depending on dosage. The novelty of this invention is simultaneously enhancing color and nutrient values to food and beverage products without changing original flavor. This invention makes food and beverage products safer and more nutritious to consumers by replacing artificial colorant and adding carotenoids and antioxidants.

### 1. PARENT CASE TEXT AND RELATED APPLICATION

This application is a continuation-in-part of U.S. Pat. No. 6,770,585 B2 issued Aug. 3, 2004

This application claims priority from U.S. provisional patent No. 62/710,052 filed on Feb. 7, 2018

### 2. FIELD OF INVENTION

The present invention relates to food, feed, beverage, food colorants. More particularly, the invention relates to formulation and methods. Accordingly, the invention involves the fields of botany, nutritional and health sciences, and medicine.

### 3. ADVANTAGES

The novelty of this invention is simultaneously enhancing color and nutrient values of food and beverage products without changing original flavor.

The advantages of this invention are in making food and beverage products safer and more nutritious for consumers by replacing artificial colorant and adding carotenoids and antioxidants.

### 4. SUMMARY OF INVENTION

This invention describes a method and composition to add natural color and nutrients to food and beverage products, using the seed pulp (aril) of Momordica cochinchinensis Spreng (Gac, redmelon, gacmelon). The fruit contains high concentrations of carotenoids and antioxidants. Other nutrients are vitamin C, vitamin E and essential fatty acids. Due to high concentrations of carotenoids, the aril has an intense color, ranging from deep orange to red depending on concentration. The novelty of this invention is simultaneously enhancing color and nutrient values in food and beverage products without changing original flavor. This invention makes food and beverage products safer and more nutritious for consumers by replacing artificial colorant and adding carotenoids and antioxidants.

### 5. BACKGROUND AND PRIOR ART

Momordica cochinchinensis (Lour.) Spreng, belongs to the melon family (Cucurbitaceae) and is indigenous to Southeast Asia and consumed there for dietary as well as medicinal uses. However, it is almost unknown to Western cultures. In Vietnam, this plant is called “Gac”, and the seed membrane (seed pulp or aril), and seeds of the ripe fruit is widely used, while the rind and peels are discarded. The rind (mesocarp, meat) of the green fruit is used in some regions in South East Asia in vegetable dishes. As the fruit ripens, the mesocarp becomes thicker, spongy and yellow-orange. The cavity is divided into cartilaginous chambers containing bright red fleshy seed pods. A ripen Gac fruit contains 19% pulp (aril). On average total carotenoid concentrations (±standard deviation) in Gac pulp is about 400 μg per g fresh material with lycopene dominating and exceeding beta-carotene concentrations by a factor of approximately 5. Gac fruit has many potential health benefits for its high carotenoid content. Carotenoids are natural pigments that occur in bacteria, plants, fungi, and animals. Carotenoids comprise a class of hydrocarbons (carotenes) and their oxygenated derivatives (xanthophylls). Most carotenoids are 40 carbon isoprenoid compounds called tetraterpenes. Carotenoids having fewer than 40 carbons can result from loss of carbons within the chain (norcarotenoids) or loss of carbons from the end of the molecule (apocarotenoids). Longer carotenoids, homocarotenoids (C45-C50), are found in some bacterial species. The alternating double bonds along the backbone of carotenoid molecules form a polyene chain, which imparts unique qualities to this group of compounds. This alternation of single and double bonds also allows a number of geometrical isomers to exist for each carotenoid. Carotenoids exist in both trans- and cis-isomeric forms of which the former can be converted to the latter by exposure to light, heat, or chemical reaction. Carotenoids cannot be synthesized by humans, hence, must be obtained from dietary sources. For humans the most important sources for carotenoids are plants. These are primarily highly pigmented red, orange, and yellow fruits and vegetables. Exemplary carotenoids found in fruits and vegetables are lycopene, .beta.-carotene, lutein, zeaxanthin, lutein plus zeaxanthin, .beta.-cryptoxanthin, and .alpha.-carotene. Carotenoids are important factors in human health. The essential role of .beta.-carotenc as an important dietary source of vitamin A has been known for many years. More recently, protective effects of carotenoids against serious disorders such as cancer, heart disease, and degenerative eye disease have been recognized. Lycopene is typically the carotenoid consumed in greatest amounts in Western diets. Per capita intakes in Europe and North America average from 1.6 to more than 18 mg lycopene per day. Processed foods are frequently fortified with carotenoids such as lycopene to increase nutritive value and/or enhance attractiveness. Carotenoids act as antioxidants and/or singlet oxygen quenchers or as free radical scavengers. With 11 conjugated double bonds and no cyclic groups, lycopene is the most potent biological antioxidant. Of the many health benefits attributed to the consumption of carotenoids, these provide the greatest clinical depth. Lycopene is an important antioxidant and free radical scavenger. Free radicals can cause damage both to the structure and to the function of cell membranes, DNA, and proteins. This damage has been linked to the onset of many degenerative diseases such as cancer, atherosclerosis, cataracts, and age-related macular degeneration as well as to premature aging. The free radical quenching constant of lycopene has been demonstrated to be more than twice that of .beta.-carotene. Lycopene is incorporated into lipoproteins. There it acts to decrease the oxidation of cholesterol, helping to prevent vascular damage. Lycopene in the blood has been shown to be inversely proportional to the incidence of prostate tumors. Research shows lycopene may provide protection against a broad range of epithelial cancers. Carotenoids are broadly used as dietary supplements due to their antioxidant potential, and lycopene has a strong presence in the nutraceuticals market.

A method using no chemicals to extract beta-carotene from Momordica cochinchinensis (Gac fruit) was described by Vuong in U.S. Pat. No. 6,770,585 filed Aug. 2, 2002. This patent claimed a process to produce an oil rich in carotenoids to be used as a safe source of dietary supplement of vitamin A. A process filed subsequently by Ishida et al. (U.S. Pat. No. 7,572,468) dexcribed a process using chemincal solvent to extract carotenoids from plants, including Gac fruit. In U.S. Patent 20070212433) Smidt et al. described beverage compositions using Gac fruit in combination with Cili fruit extract, Siberian pineapple extract, and a Wolfberry extract.

In U.S. Pat. No. 5,942,233 Chang, Shan described the use of Momordica cochinchinensis as one of the component in a paste that is useful for re-establishing of vital energy invigorating of blood circulation. U.S. Pat. No. A 8,017,147, described compositions for the prevention of cardiovascular disease, alzheimer's disease, diabetes, and regulation and reduction of blood sugar and insulin resistance. The inventor mistakenly listed “Momordica chinensis” as a synonym of Bitter Melon (Momordica charantia). U.S. Pat. No. 8,668,942 (Vuong) described the use of the oil extract from Momordica cochinchinensis in skin anti-oxidant enhancing formulations. Foreign invention filed on the use of Momordica cochinchinensis to treat skin disorders are either based on components from inside the seeds or from the root of the plant, or a mixture of many different plants.

Shewmaker in U.S. Pat. No. 6,972,351 (Dec. 6, 2005) described methods for producing oil from plants and seeds. The patent also described methods to increase the carotenoid levels in oilseed plants and provide desirable high oleic acid seed oils compositions. Other patents filed on the use of natural products for colorant or ingredients are listed below: U.S. Pat. No. 9,750,780 described aqueous-lipidic carotenoid-containing compositions comprising an aqua-containing component, a lipid-containing component and a carotenoid-containing fiber material from plant origin with lowered content of aqua-soluble substances.

U.S. Pat. No. 9,624,354 by Rossi, et al. described a colorant composition having high color intensity and/or low sugar content. The colorant composition comprising a crystalline pigment or mixture of pigments derived from plants or algae consisting of anthocyanins, carotenoids, betalains, curcumin, carminic acid, carminic acid derivatives, chlorophyll, and chlorophyll derivatives. Although carotenoids were listed in this invention, they are specified as in crystalline form and not from Momordica cochinchinensis Spreng. Syed Muhammad in U.S. Pat. No. 9,028,891 described method to use materials from Dragon fruit in food, cosmetics, supplement and drugs. Zelkha, et al. (U.S. Pat. No. 7,641,931, Jan. 5, 2010) described a tomato pulp composition which does not contain seeds or peels and has a high lycopene concentration. The invention further provides an industrial process for obtaining tomato pulp and tomato concentrate from tomato juice. Klamerus in U.S. Pat. No. 7,413,757 described method to make a color-stable, cooked, flour-based food that can be colored red from red radish extract. Lee, et al. in U.S. Pat. No. 9,877,500 (Jan. 30, 2018) described natural beverage products natural comprise of an acidulant comprising lactic acid and at least one of tartaric and citric acids, optionally other natural carboxylic acids and no phosphoric acid.

In U.S. Pat. No. 9,427,007 Mason, et al. described a method using a multiple emulsion of the water-in-oil-in-water (W/O/W) type for stabilization of natural coloring agents, such as anthocyanin, phycocyanin, carthamus, huito, calcium carbonate, carmine and carminic acid, against changes in pH values, oxidation and light as well as against ingredient interactions. Yukawa, et al. in U.S. Pat. No. 6,936,292 described a deodorized Carthamus yellow colorant from safflower. The invention described the formula as acetic acid, isovaleric acid, phenylethyl alcohol, phenol, 4-vinyl phenol).

Fonte in U.S. Pat. No. 6,224,922 described a specialty beverage container with a multiple colorant reservoir with a number of colorant chambers allowing consumer to choose and drinks the beverage colored to his specifications.

Wrolstad, et al. in U.S. Pat. No. 6,180,154 described methods for extracting anthocyanin pigments from red-fleshed potatoes without use of an organic solvent to produce a natural colorant having a red-hue equivalent to FD&C Red No. 40.

Dierbach, et al. in U.S. Pat. No. 9,883,691 described methods of modifying flavor of food and beverage products using 1,3-propanediol.

Akao in U.S. Pat. No. 9,636,373 described beverage composition using kava extract.

Runge, et al. in U.S. Pat. No. 6,287,615 described the use of solubilized carotenoid preparations for coloring foods.

None of the above patents described the use of Momordica cochinchinensis aril in adding color to foods and beverage products.

### 6. DETAILED DESCRIPTION OF INVENTION

The present invention relates to formulations and methods using the aril of Momordica cochinchinensis (Gac, redmelon) to add color and nutrients to foods and drinks.

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting.

### 7. DEFINITION OF TERMS

In describing and claiming the present invention, the following terminology will be used.

The singular forms “a,” “an,” and “the” include plural referents unless the context clearly dictates otherwise. Thus, for example, reference to “a carrier” includes reference to one or more of such carriers, and reference to “an excipient” includes reference to one or more of such excipients.

As used herein, “formulation” and “composition” may be used interchangeably herein, and refer to a combination of two or more elements, or substances. In some embodiments a composition may include an active agent and a carrier.

As used herein, “effective amount” refers to an amount of an ingredient, namely composition, is sufficient to be able to detect by available analytical tool by qualified persons.

The term Redmelon or Gacmelon or Gac or “Gac fruit” or “Gac plant” may be used interchangeably herein.

The term “Gac Fruit,” “Gac Extract,” “Gac fruit extract,” “Gac Fruit Puree,” “Gac powder,” “Gac oil,” “Gac fruit oil” refer to a product made from the fruit of all strains and hybrids of the plant Momordica cochinchinensis Spreng, or of plants significantly related thereto, grown anywhere in the world including blends, mixtures, and combinations of such strains and relatives.

As used herein, the term “conventional carotene drink” or “conventional beverage” refers to beverage in any form which do not contain Gac fruit or a Gac fruit extract.

### 8. DETAILED DESCRIPTION OF THE INVENTION

The present invention encompasses methods and formulations to add color and at the same time enhance nutrients of foods and beverages. This present invention described the use of Momordica cochinchinensis Spreng. (gac, redmelon, gac melon) as a natural food colorant. Gac fruit is a variety of melon, indigenous to South East Asia. The ripe fruit has a large amount of aril (seed pulp) which has no flavor, but an intense reddish color. The colors can range from yellow, orange, to red, depending on the ripeness and variety of Gac fruit. To produce aril, fruit is cut opened; seed pulp is removed manually or by machine. Seed pulp is scrapped off the seeds, either manually, using a knife, or by machine. Seed pulp contains beta-carotene, lutein, lycopene, vitamin C, vitamin E, and essential fatty acids (omega-3,-6,-9). Pulp also contains fiber, protein and oil. Gac pulp is mechanically blended into puree and can used directly in foods or beverage or can further be subjected to a reduction in particle size by go through a sieve. The pulp slurry can also be converted into a solid particulate form, having a moisture content of less than 10 wt %. The dried powder is subjected to a second reduction in particle size, by a high speed centrifuge where the residual solids are discharged and the liquid directed to an evaporator.

In one embodiment, the aril puree is strained to produce a fruit mixture with orange color. The mixture can be sweetened by sugar, honey, monk fruit extract or Lo Han Guo extract or other natural sweeteners suitable for at least certain exemplary embodiments include, for example, sucrose, liquid sucrose, fructose, liquid fructose, glucose, liquid glucose, glucose-fructose syrup from natural sources such as apple, chicory, honey, etc., e.g., high fructose corn syrup, invert sugar, sorbitol, mannitol, xylitol, glycyrrhizin, d-tagatose, erythritol, meso-erythritol, malitol, maltose, lactose, fructo-oligosaccharides, rcbaudioside a, stevioside, other steviol glycosides, stevia rebaudiana extracts, xylose, arabinose, isomalt, lactitol, maltitol, trehalose, rhamnose, and ribose, and protein sweeteners such as monatin, thaumatin, monellin, brazzein, 1-alanine and glycine. Sweetened gac pulp puree can be made into a syrup.

It will be within the ability of those skilled in the art, given the benefit of this disclosure, to select suitable additional or alternative sweeteners for use in various embodiments of the food and beverage products disclosed here.

Gac pulp mixture either in puree, powder or syrup can be used to add color and nutrients to yogurt, cakemix or cooked rice.

In one embodiment, Gac pulp puree is mixed well with water and rice to produce a red rice dish. In another embodiment, the fruit mixture is added to purified water to make a sport drink containing carotenoids, and antioxidants. In another embodiment, the fruit mixture with or without sweetener is added to cononut drink for added color and nutrients.

In another embodiment, lemon juice, or ascorbic acid is added to improve taste. In another embodiment, CO2 is added to the water+fruit mixture to produce a carbonated drink. In another aspect of the present invention, the Gac pulp mixture is used in the process of ice-cream making to produce an orange color product containing carotenoids and antioxidants.

It is to be understood that the above-described embodiments are only illustrative of the application of the principles of the present invention. Numerous modifications and alternative formulations can be devised by those skilled in the art without departing from the spirit and scope of the present invention. Thus, while the present invention has been fully described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

### EXAMPLES

The following examples are given to illustrate various embodiments which have been made or may be made in accordance with the present invention. These examples are given by way of examples only, and it is to be understood that the following examples are not comprehensive or exhaustive of the many types of embodiments of the present invention which can be prepared in accordance with the present invention.

### Example 1

Red rice high in vitamins

| Ingredients | Weight (g) | |
|---|---|---|
| Gac pulp puree | 100 | g |
| Sweet rice | 1 | cup |
| Coconut milk | ½ | cups |
| Water | 1 | cups |

Mix gac pulp puree in coconut milk.

Soak rice in water overnight until all liquid is absorbed. Carefully mix wet rice with coconut milk and gac puree mixture until the rice is well colored. Pour the colored rice into a steamer and steam about 20 minutes until cooked.

### Example 2

Antioxidant sport drink colored with Gac puree

| Ingredients | Weight (g) |
|---|---|
| Gac pulp puree | 100 g |
| Liquid sucrose | 485.5 |
| Citric acid, anhydrous | 3.745 |
| Concentrated apple extract | 30.0 |

Treated water Quantity sufficient for 1 liter total volume

A sport drink containing antioxidants can be prepared by dissolving the above ingredients with vigorous stirring in sufficient water to obtain 1 liter of syrup. The syrup was diluted with carbonated water in a 1 plus 5 “throw” (one volume of syrup plus five volumes of carbonated water) to produce a finished beverage. The beverage was then subjected to tunnel pasteurization at 155.degree. F. for 10 minutes. The beverage made according to this example has a pink color, a very refreshing taste, and highly nutritious.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) In this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

The scope of the invention is, therefore, indicated by the appended claims rather than by the forgoing description.

### 9. REFERENCES

### References Cited [Referenced By]

U.S. Patent Documents

| | | |
|---|---|---|
| 6,770,585 | Aug. 3, 2004 | Vuong |
| 8,868,942 | Mar. 11, 2014 | Vuong |
| 3,172,770 | March 1965 | Miller |
| 5,245,095 | September 1993 | Graves et al. |
| 5,274,073 | December 1993 | Gruber et al. |
| 5,462,695 | October 1995 | Tsai et al. |
| 5,686,489 | November 1997 | Yu et al. |
| 5,714,658 | February 1998 | Heidlas et al. |
| 5,773,075 | June 1998 | Todd |
| 5,789,647 | August 1998 | Heidlas et al. |
| 5,830,738 | November 1998 | Thomas et al. |
| 5,837,311 | November 1998 | Zelkha et al. |
| 5,871,574 | February 1999 | Kawaragi et al. |
| 5,897,866 | April 1999 | Bombardelli et al. |
| 6,818,239 | November 2004 | Kagan et al. |
| 2003/0052424 | March 2003 | Turner et al. |
| 2003/0061761 | April 2003 | Nanninga et al. |
| 2003/0180435 | September 2003 | Shi |
| 2004/0115260 | June 2004 | Schmid et al. |
| 2004/0131733 | July 2004 | Rey et al. |
| 2004/0208983 | October 2004 | Hill et al. |
| 8,017,147 | Sep. 13, 2011 | Mazed; Mohammad A |
| 9,750,780 | Sep. 5, 2017 | Druzhinin |
| 0,212,433 | September 2007 | Smidt et al. |
| 9,624,354 | Apr. 18, 2017 | Rossi, et al. |
| 9,028,891 | May 12, 2015 | Syed Muhammad, et al. |
| 7,641,931 | Jan. 5, 2010 | Zelkha, et al. |
| 7,413,757 | Aug. 19, 2008 | Klamerus |
| 9,877,500 | January 2018 | Lee, et al. |
| 9,427,007 | Aug. 30, 2016 | Mason, et al. |
| 6,936,292 | Aug. 30, 2005 | Yukawa, et al. |
| 6,224,922 | May 1, 2001 | Fonte |
| 6,180,154 | Jan. 30, 2001 | Wrolstad, et al. |
| 9,883,691 | Feb. 6, 2018 | Dierbach, et al. |
| 9,636,373 | May 2, 2017 | Akao |
| 6,287,615 | Sep. 11, 2001 | Runge, et al. |
| 6,972,351 | Dec. 6, 2005 | Shewmaker |
| 7,572,468 | Aug. 11, 2009 | Ishida, et al. |

Foreign Patent Documents

| | | |
|---|---|---|
| 53118597 | October 1978 | JP |

### Other References

BAILEY, L. H. (1937). The Garden of Gourds; The Macmillian Company pp 121-22. New York.
TRISONTHI, C. (1992). Description et de d′identification de quelques fruits tropicaux comestibles (Descriptions and keys for the identification of some edible tropical fruits). Fruits, 47, 425-449.
CHIANG, S. (1977). Dictionary of Chinese Curde Drugs (New Medical College, E.), Scientific Technologic Publisher pp 370. Shanghai, China.
IWAMOTO, M., Okabe, H., Yamauchi, T. (1985). Studies on the constituents of Momordica Cochinchinensis Spreng. Chem Pharm Bull. 33, 1-7.
HASAN, C. M.; Reza-ul-Jal Rabbar, A., Waterman, P. (1987). Chondrillasterol from the tubers of Momordica Cochinchinensis. Plant Med. 53(6), 578-9.
SHADEQUE, A.; Baruah, G. (1984). Sweet gourd: a popular vegetable of Assam. Indian Farming. 34:25-35.
NAGAO, Y., Fujioka, S., Tsukui, M., Matsuoka, T. (1977). Studies on breeding and cultivation of medicinal plants—The cultivation and the quality of Momordica Cochinchinensis Spreng. J Takeda Res Lab. 36, 193-9.
HERKLOTS, G. A. C. (1972). Vegetables in South-East Asia. George Allen & Unwin LTD, London.
PERRY, L. M. (1980). Medicinal Plants of East and Southeast Asia, Attributed Properties and Uses. The MIT Press, Cambridge.
DO, T. L. (1991). Nhung Cay Thuoc va Vi Thuoc Vietnam [A Compilation of Medicinal Plants of Vietnam]. Nha Xuat Ban Khoa Hoc va Ky Thuat, Hanoi.
NGUYEN, D. V. (1998). Medicinal Plants of Vietnam, Cambodia and Laos. Mekong Printing, California.
BUI, C. X., Do, B. H., Pham, M. K., Do, D. T., Nguyen, T. T., Pham, K. T. (1990). Cay Thuoc Vietnam (Medicinal Plants of Vietnam). Nha Xuat Ban Khoa Hoc va Ky Thuat, Hanoi.
VO, V. C. (1997). Tu Dien Cay Thuoc Vietnam [A dictionary of Medicinal Plants of Vietnam]. Nha Xuat Ban Y-Hoc, Ho-Chi-Minh City.
VUONG, L. T., Dueker, S. R., Murphy, S. P. (2002). Plasma beta-carotene and retinol concentrations of children increase after a 30-d supplementation with the fruit Momordica cochinchinensis (gac). Am J Clin Nutr., May, 75(5), 872-9.
VUONG, L., Chitchumroonchokchai C.; Chapman M.; Ishida B.; King J.; Failla M. (2003), High bioaccessibility of carotenes and lycopenes in gac oil and gac fruit aril. The FASEB Journal.
KHACHIK, F.; Beecher, G. R.; Goli, M. B.; Lusby, W. R.(1992). Separation and Quantitation of Carotenoids in Foods. Methods in Enzymology., 213, 347-359.
HANDELMAN G. (1992). High Resolution Analysis of Carotenoids in Human Plasma by High-Performance Lipid Chromatography, Methods in Enzymology, 213, 336-346.
FRANKE, A.; Custer, L.; Cooney, R. (1993). Quantitation of Lipid-Phase Micronutrients in Plasma by HPLC with Synthetic Carotenoids as Internal Standards. J. Chromatogr., 614, 43-57.
VIEN Dinh Duong (1995). Thanh Phan Dinh Duong Thuc An Viet Nam [Food Products in Vietnam Composition and Nutritive Value]. Nha Xuat Ban Y Hoc, Hanoi.
VUONG L. T. (2000). Under-utilized beta-carotene-rich crops of Vietnam. Food and Nutrition Bulletin, 2:2, 173-81.
AOKI, H.; Kieu, N. T.; Kuze, N.; Tomisaka, K; Chuyen V. N. (2002). Carotenoid pigments in GAC fruit (Momordica cochinchinensis SPRENG). Biosci Biotechnol Biochem., 66(11),2479-82.
ISHIDA B. K., Turner, C., Chapman M. H., McKeon T. (2004). Fatty acid and carotenoid composition of Gac (Momordica cochinchinensis Spreng) Fruit. J. Agric. Food Chem. 52, 274-79.
BAUERNFIELD, J. C. (1971). Carotenoid vitamin A precursors and analogs in foods and feeds. J. Ag. Food Chem. 20, 456-73.
WEST, C. E., Poortvliet, E. J. (1993). The Carotenoid Content Of Foods With Special Reference To Developing Countries. USAID-VITAL, Washington D. C.
RODRIGUEZ, D. B.; Raymundo, L. C.; Lee, T. C.; Simpson, K. L.; Chichester, C. O. (1976). Carotenoid Pigment Changes in Ripening Momordica charantia Fruits. Ann. Bot, 40, 615-624.
U.S. Department of Agriculture, Agricultural Research Service (2003). USDA Nutrition Database for Standard Reference, Release 16. Retrieved Jun. 13, 2003 from the Nutrient Data Laboratory Home Page on the World Wide Web:http://www.nal.usda.gov/fnic/foodcomp.
RIBAYA-MERCADO, J. D. (2002). Influence of dietary fat on beta-carotene absorption and bioconversion into vitamin A. Nutr Rev. 60, 104-110.
VAN HET HOF, K. H., West, C. E., Weststrate, J. A., Hautvast, J. G. (2000). Dietary factors that affect the bioavailability of carotenoids. J Nutr, 130, 503-506.
WILLIAMS, A. W., Boileau, T. W., Erdman, J. W. Jr (1998). Factors influencing the uptake and absorption of carotenoids. Proc Soc Exp Biol Med, 218, 106-108. http://web.archive.org/web/20030509095459/http://www.whfoods.org/genpage.p-hp?tname=foodspice&dbid=34. cited by examiner. http://www.aaccnet.org/meetings/2001/Abstracts/a01ma154.htm.
Li, 2002, Product development of sea buckthorn, Trends in new crops and new uses, pp. 393-398. cited by examiner.
Vuong, A method of preserving and testing the acceptability of gac fruit oil, a good source of beta-carotene and essential fatty acid, 2003, Food Nutr Bull, 24, 372-3. cited by examiner.
Solomon, in response to Vuong and King, “A method of preserving and testing the acceptability og gac fruit oil, a good cource of beta-carotene and essential fatty acids,” 2003, Food and Nutrition Bulletin, 24: 372-374. cited by examiner.
Vuong and King, “A method of preserving and testing the acceptability og gac fruit oil, a good cource of beta-carotene and essential fatty acids,” 2003, Food and Nutrition Bulletin, 24: 224-230. cited by examiner.
Le T. Vuong, Stephen R. Dueker, and Suzanne P Murphy, Plasma .beta.-carotene and retinol concentrations of children increase after a 30-d supplementation with the fruit Momordica cochinchinensis (gac). American Society for Clinical Nutrition. 2002. 872-9. cited by other.
Hiromitsu Aoki, Nguyen Thi Minh Kieu, Noriko Kuze, Kazue Tomisaka and Nguyen Van Chuyen, Carotenoid Pigments in GAC Fruit (Mamordica cochinchinensis Spreng), Biosci. Biotechnol. Biochem., 2002, 2479-2482, 66(11). cited by other.
Doug Burke, Genesis Juice, Feb. 1, 2005. cited by other.
Pharmanex introduces G3 nutrition drink, scientifically shown to have high levels of antioxidants. Press Release [online], Pharmanex, Mar. 17, 2005 [retrieved on Oct. 11, 2007]. Retrieved from Internet: URL:http://www.pharmanex.com/corp/pharmanews/pressreleases/03-1-7-05.shtml. cited by other.
Clinical study: Validation of non-invasive raman spectroscopy as an indicator of total antioxidant nutritional status in humans. Datasheet [online], Pharmanex. October 2005 (retrieved on Oct. 18, 2007), URL: http://download.oneteamglobal.com/us/info.sub.-studies/scanner/ClinicalS-tudy.pdf. cited by other.

What is claimed:

1. A method of simultaneously improving nutrient content (especially of carotenoids) and natural color of a food or beverage formulation by adding an effective amount of Momordica cochinchinensis Spreng (Gac) aril;

2. The method in claim 1 wherein the Gac aril is produced by removing seed pulp from a ripe Gac fruit, then separating the pulp from the seeds;

3. The method in claim 2 wherein the Gac aril component can be fresh or frozen puree, dried powder, or syrup;

4. The method in claim 3 wherein the added nutrients in the mixture are: antioxidants, carotenoids, pre-vitamin A, lycopene, lutein, vitamin C and vitamin E;

5. The method in claim 3 wherein concentration of total carotenoids in the mixture is at least 4 mg per 100 g of mixture;

6. The method in claim 3 wherein the color of the end mixture will change into the range of light orange to red;

7. The method in claim 3 wherein food product can be yogurt, pasta, rice, flour, candies, or condiments or sauces;

8. The method in claim 3 wherein drinkable liquid can be water, carbonated water, flavored, coconut water, non-dairy milk (coconut milk, almond milk, soy milk), breast milk, or dairy milk;

9. The method in claim 3 wherein food products include pet food;

10. The method in claim 3 wherein food products include baby food;

11. The method in claim 3 wherein drinkable liquid include infant formula;

12. The method in claim 3 wherein other ingredients can be sugar or sweeteners, or salt;

13. The method in claim 3 wherein other ingredients can be natural or artificial fruit extracts or flavors;

14. The method in claim 3 wherein other ingredients can include carbon dioxide, carbohydrate or an enzyme;

15. The method in claim 3 wherein other ingredients can include an emulsifier and/or a stabilizer, preservative, ascorbic acid, or citric acid;
